(19) United States
(12) Patent Application Publication
(10) Pub. No.: US 2003/0086083 A1
(43) Pub. Date: May 8, 2003

(54) Optical metrology tool with dual camera path for simultaneous high and low magnification imaging

(76) Inventors: Martin Ebert, Fremont, CA (US); Li Chen, Fremont, CA (US)

Correspondence Address: STALLMAN & POLLOCK LLP, Suite 290, 121 Spear Street, San Francisco, CA, 94105, US

(21) Appl. No.: 10/278,562

(22) Filed: Oct. 23, 2002

Related U.S. Application Data
(60) Provisional application No. 60/336,516, filed on Nov. 1, 2001.

(51) Int. Cl. G01N 21/00

(52) U.S. Cl. 356/237.2

(57) ABSTRACT

A positioning subsystem for an optical metrology tool includes a beam splitter that receives light reflected by an area of interest within a subject. The beam splitter divides the reflected light and directs the result along separate high and low magnification paths. The high and low magnification paths each include one or more lenses. The lenses on the low magnification path create a low magnification image of the area of interest that is used to perform rough positioning of the subject. The lenses on the high magnification path create a high magnification image of the area of interest that is used to refine the rough positioning of the subject.

### PRIORITY CLAIM

The present application claims priority to U.S. Provisional Patent Application Serial No. 60/336,516, filed Nov. 1, 2001, which is incorporated herein by reference.

### TECHNICAL FIELD

This subject invention relates to an optical metrology tool that includes two imaging paths to support simultaneous high and low magnifications of a subject under test.

### BACKGROUND OF THE INVENTION

As geometries continue to shrink, manufacturers have increasingly turned to optical techniques to perform non-destructive inspection and analysis of semi-conductor wafers. The basis for these techniques is the notion that a subject may be examined by analyzing the reflected energy that results when a probe beam is directed at the subject. Ellipsometry and reflectometry are two examples of commonly used optical techniques. For the specific case of ellipsometry, changes in the polarization state of the probe beam are analyzed. Reflectometry is similar, except that changes in magnitude are analyzed. Ellipsometry and reflectometry are effective methods for measuring a wide range of attributes including information about thickness, crystallinity, composition and refractive index. The structural details of ellipsometers are more fully described in U.S. Pat. Nos. 5,910,842 and 5,798,837 both of which are incorporated in this document by reference.

As shown in FIG. 1, a typical ellipsometer or reflectometer includes an illumination source that creates a mono or polychromatic probe beam. The probe beam is focused by one or more lenses to create an illumination spot on the surface of the subject under test. A second lens (or lenses) images the illumination spot (or a portion of the illumination spot) to a detector. The detector captures (or otherwise processes) the received image. A processor analyzes the data collected by the detector.

Accurately locating the illumination spot within the subject under test is an essential part of the measurement process. As shown in FIG. 2, this is generally accomplished using a positioning subsystem. The positioning subsystem includes an illumination source which may be combined or separate from the illumination source used to generate the probe beam. The illumination source generates a beam of visible light. The visible light beam is directed (in this case by a beam splitter and one or more lenses) to irradiate an area of interest on the subject. The area of interest is generally larger and includes the illumination spot. The reflected light from the area of interest is focused by one or more lenses before reaching a camera. The camera provides an image of the area of interest, allowing an operator to correctly position the subject for analysis.

Increasingly small features and increasingly large wafers make optical positioning increasingly difficult to use. This is especially true in production environments where time if often of the essence. To compensate, and as shown in FIG. 2, the positioning subsystem generally includes a magnification system between the camera and the subject under test. The magnification system typically includes separate low and high magnification optics. The low magnification optics are used to rapidly position the subject with relatively low accuracy. The high magnification optics are used to refine the location of the subject until the desired accuracy is achieved.

For semi-conductor application, each subject (wafer) is fabricated as a repeating pattern of separate die. The inspection process typically visits one or more of these die in a predetermined sequence. At each visited die, one or more sites are examined. Thus, accurate inspection requires accurate location of individual die and accurate location of individual sites within their containing die.

Before the inspection process can begin, it is generally necessary to accurately locate the position of the repeating pattern of die on the wafer. This step, known as mask alignment, is necessary because it is possible for the location of the pattern to vary between different wafers. Typically, this location step is performed by moving the subject to a known position. The actual and expected positions of a known feature are then compared to generate an offset that is used to adjust all subsequent movements of the subject. In many cases, the known feature is actually a periodic feature that can be found by translating the subject along one axis allowing the determination of translation and rotation offsets.

Once the die pattern has been located, the positioning subsystem must then accurately locate each of the sites within each visited die. To facilitate this portion of the process, a known feature is identified for each inspection site. As the subject is positioned to measure a particular site, the location of the associated reference feature is measured. The measured location is compared to an expected location and the difference is used to compute a positioning error and a corresponding corrective movement of the subject. In this way, the accuracy of the positioning subsystem is dynamically recalculated. The image provided by the low magnification optics is used during the initial positioning of the subject at each site. The wider angle of view associated with the low magnification optics provides a single image that includes both a site and its associated reference feature. The high magnification optics allow the position to be refined to a high degree of accuracy.

To provide low and high magnification optics, the magnification system typically includes both sets of optics as part of a turret-like device. The turret is rotated to select the desired set. Unfortunately, turret based (and other mechanical systems) have a tendency to experience positioning changes due to wear and temperature effects. These positioning changes are indistinguishable from stage positioning errors, and absent recalibration may result in positioning errors. Mechanical systems can also result in the creation of minute particles which can further influence the accuracy of the mechanical selection systems. Mechanical selection systems also require time to operate. This inevitably introduces delays into the measurement process as desired optics are brought into alignment.

For these reasons, a need exists for improved systems for imaging subjects during the positioning process. This need is particularly relevant for semiconductor applications where shrinking geometries require increasingly small illumination spots and increasingly accurate positioning.

### SUMMARY OF THE INVENTION

The present invention provides a positioning subsystem for use within an optical metrology tool. The positioning subsystem provides a dual channel output to provide simultaneous high and low magnification images of an area of interest on the subject. To provide these two images, the positioning subsystem includes an illumination source generating a beam of visible light. The visible light beam is directed to irradiate an area of interest on the subject. The reflected light from the area of interest is focused by one or more lenses and passed through a beam splitter. The beam splitter divides the reflected light into two distinct beams. One of these is passed through a set of low magnification optics before reaching a first camera. The first camera provides a low magnification image of the area of interest and allows an operator to coarsely position the subject for analysis. The second of the beams is passed through a set of high magnification optics before reaching a second camera. The second camera provides a high magnification image of the area of interest and is used to refine the position obtained with the low magnification image. In this way, the positioning subsystem provides. accurate positioning without the delays and wear-induced errors associated with mechanically selected optical components.

### BRIEF DESCRIPTION OF THE DRAWINGS

FIG. 1 is a diagram of ellipsometer or reflectometer shown to describe prior art for the present invention.

FIG. 2 is a diagram of ellipsometer or reflectometer with a positioning subsystem shown to describe prior art for the present invention.

FIG. 3 is a diagram of optical metrology system shown with a positioning subsystem as provided by the present invention.

FIG. 4 is a diagram showing the positioning subsystem of FIG. 3.

FIG. 5 shows the positioning subsystem of FIG. 3 deployed as part of a representative optical metrology tool.

FIG. 6 is an alternate layout for the positioning subsystem of FIG. 3.

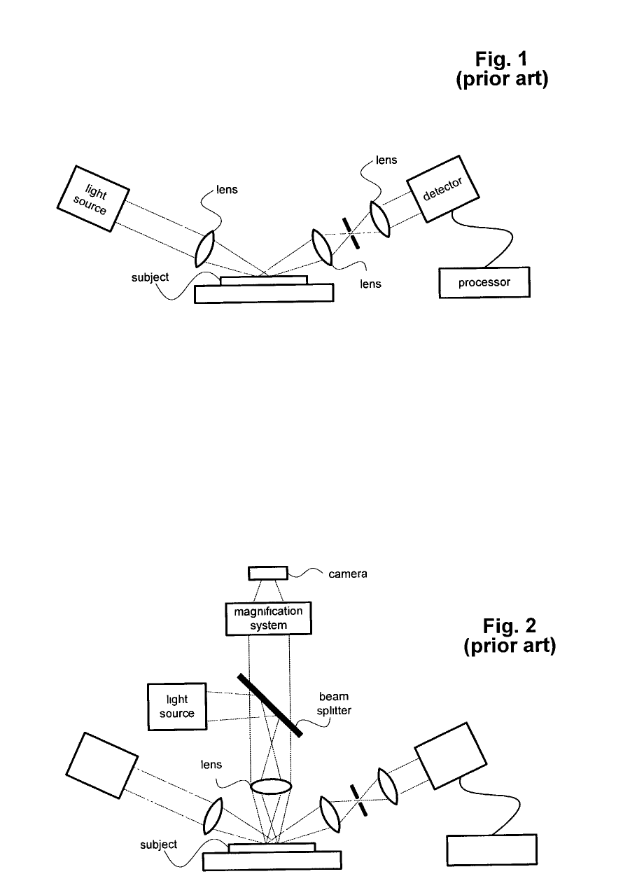

### DETAILED DESCRIPTION OF THE PREFERRED EMBODIMENTS

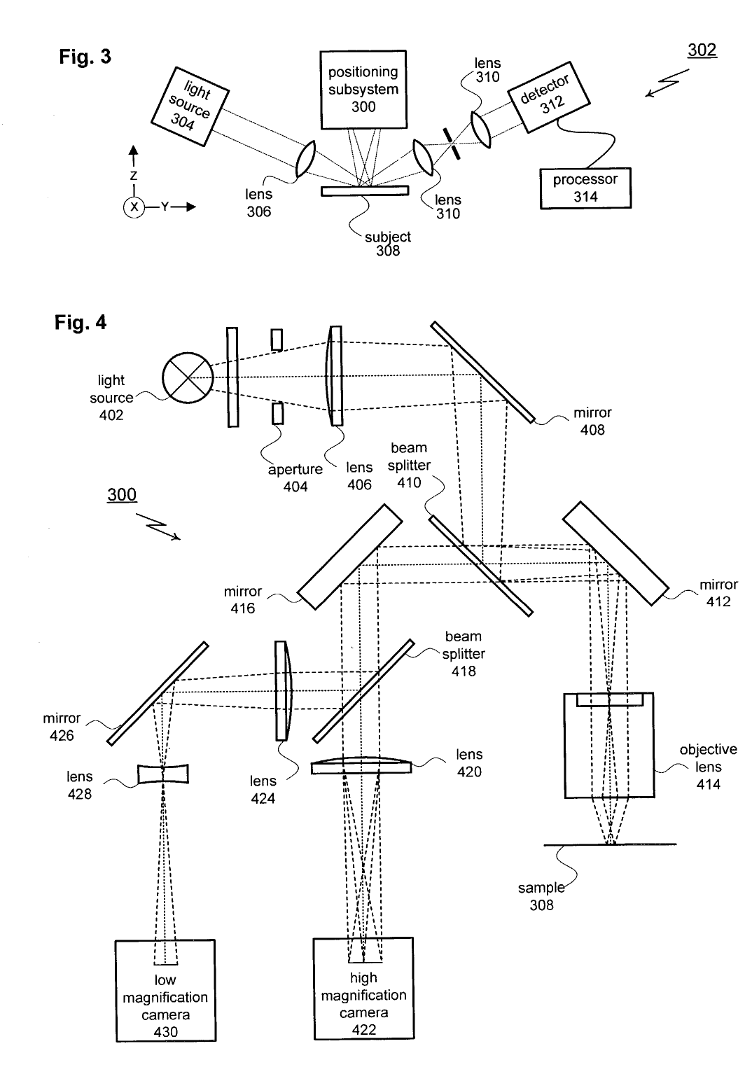

As shown in FIG. 3 the present invention includes a positioning subsystem 300 for use within an optical metrology tool 302. Optical metrology tool 302 is intended to be representative of the wide range of tools of this type, including ellipsometers, reflectometers, and scatterometers. For this particular example, optical metrology tool 302 includes an illumination source 304 that creates a mono or polychromatic probe beam. The probe beam is focused by one or more lenses 306 to create an illumination spot on the surface of the subject under test 308. A second lens 310 (or lenses) images the illumination spot (or a portion of the illumination spot) to a detector 312. The detector 312 captures (or otherwise processes) the received image. A processor 314 analyzes the data collected by the detector 312.

The subject 308 is positionable within the X-Y plane to choose the area that is covered by the illumination spot. The subject 308 is also positionable (i.e., movable in the X-Y plane) to choose the area that is covered by the illumination spot. Positioning subsystem 300 provides concurrent high and low magnification images to aid in the positioning process. As shown in more detail in FIG. 4, positioning subsystem 300 includes an illumination source 402. The illumination source 402 produces a beam of visible light that passes through an aperture 404 and is focused by a lens 406 before reaching a turning mirror 408. The turning mirror 408 and a beam splitter 410 redirect (reflect) the visible light beam towards a mirror 412. The mirror 412 redirects the visible light through an objective lens system 414 which focuses the visible light beam onto an area of interest on the surface of the sample 308. The image of the area of image (i.e., the reflection of the visible light beam) is collimated by the objective lens 414 and returned to the mirror 412. The mirror 412 returns the image through the beam splitter 410 towards a second mirror 416.

The second mirror 416 forwards the image to a second splitter 418 which divides the image into two separate paths. The first path, known as the high magnification path is passed through a lens 420 and is collected by a high magnification camera 422. The second path, known as the low magnification path is passed through a lens 424 before reaching a mirror 426. The mirror 426 directs the low magnification path through a lens 428 for collection by a low magnification camera 430. The high and low magnification cameras 422, 430 provide concurrent views of the area of interest. The use of a common objective lens 414 means that the high magnification image is coaxially included in the low magnification image (i.e., the high magnification image covers a smaller area located at the center of the low magnification image). The use of two concurrent images eliminates the wear and delay associated with mechanical interchange of optics. It should be noted that although two different images are concurrently created by the respective lens systems, it is not necessary that both cameras operate concurrently to capture those images. In fact, the user will typically be interested in only one image at a time, so if desired, the cameras can be operated sequentially.

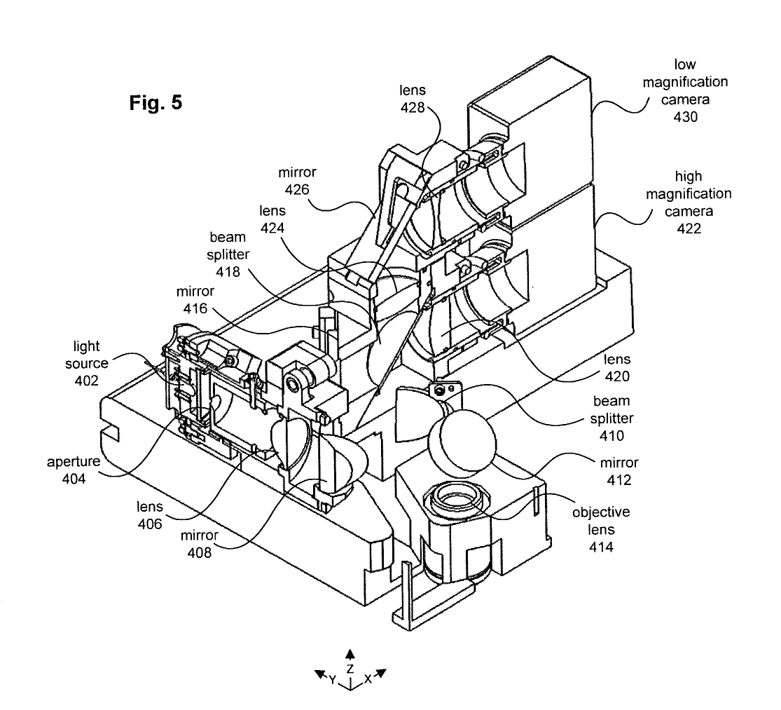

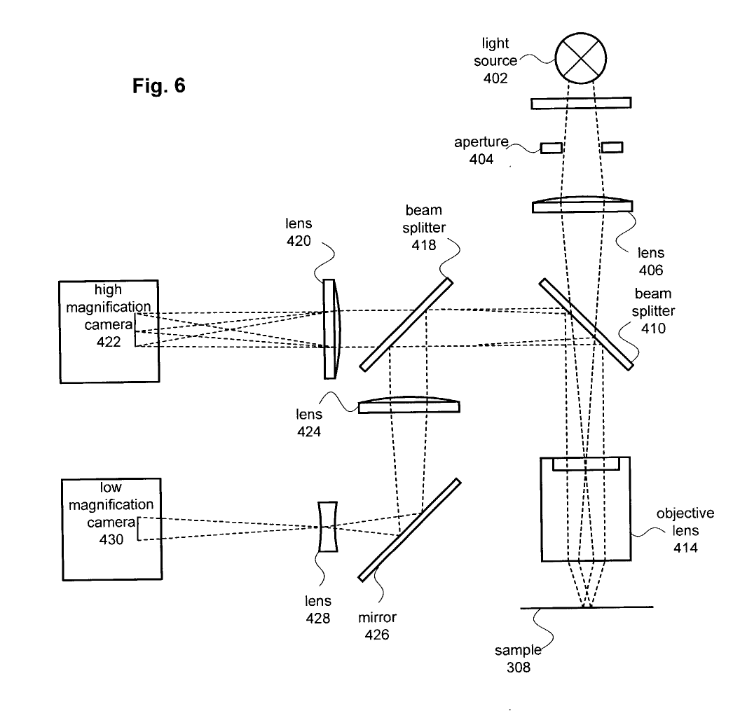

In general, it should be appreciated that the particular combination of components shown in FIG. 4 is at least somewhat dictated by the physical constraints of the optical metrology tool in which they are used. This is more easily described by reference to FIG. 5 where the optical components of FIG. 4 are shown within an associated support structure. For this implementation, light source 402, aperture 404 and lens 406 are oriented along the Y-axis. The high and low magnification cameras 422, 430 are oriented along the X-axis and the optical path through the objective lens 414 is oriented along the Z-axis. These mutually perpendicular orientations are used to efficiently house the positioning subsystem 300 within a compact three-dimensional space. In cases where this particular layout is not used, it may be possible to eliminate one or more of mirrors 408, 412, 416, 426 or beam splitters 410, 418. This is shown, for example in FIG. 6 where mirrors 408, 412, 416 have been eliminated by reoriented the light source 402 as well as the high and low magnification cameras 422, 430. In general, many such variations are possible depending on the particular constraints associated with the underlying optical metrology tool.

For semi-conductor application, optical metrology tool 302 typically inspects a predetermined sequence of sites within one or more of the dies in the subject under test 308. To initiate this process, optical metrology tool performs a mask alignment process. Typically, this process is performed by moving the subject 308 to a known position. The actual and expected positions of a known feature are then compared to generate an offset that is used to adjust all subsequent movements of the subject. In many cases, the known feature is actually a periodic feature that can be found by translating the subject 308 (i.e., a single movement along either the X or Y axis) along one axis.

Once the die pattern has been located, the positioning subsystem 300 must then accurately locate each of the sites within each visited die. To facilitate this portion of the process, a known feature is identified for each inspection site. As the subject is positioned to measure a particular site, the location of the associated reference feature is measured. The measured location is compared to an expected location and the difference is used to compute a positioning error and a corresponding corrective movement of the subject. In this way, the accuracy of the positioning subsystem 300 is dynamically recalculated. The image provided by the low magnification camera 430 is used during the initial positioning of the subject at each site. The wider angle of view associated with the low magnification camera 430 provides a single image that includes both a site and its associated reference feature. The high magnification camera 422 allows the position to be refined to a high degree of accuracy.

What is claimed is:

1. A positioning system for an optical metrology tool, the position subsystem comprising:
a beam splitter positioned to receive light reflected by an area of interest within a subject, the beam splitter directing the reflected light along separate high and low magnification paths;
one or more optical components positioned on the high magnification path to create a high magnification image of a portion of the area of interest; and
one or more optical components positioned on the low magnification path to create a low magnification image of the area of interest, the low magnification image being created concurrently with the high magnification image.

2. A positioning system as recited in claim 1 that further comprises an illumination source for irradiating the area of interest.

3. A positioning system as recited in claim 1 that further comprises an objective lens for projecting light reflected by the area of interest to the beam splitter.

4. A positioning system as recited in claim 1 that further comprises:
a first magnification camera for capturing the high magnification image; and
a second magnification camera for capturing the low magnification image.

5. A method for positioning a subject within an optical metrology tool, the method comprising:
gathering light reflected from an area of interest within the subject;
directing the reflected light along separate high and low magnification paths; and
projecting the light on the high and low magnification paths through one or more lenses to create concurrent high and low magnification images of the area of interest.

6. A method as recited in claim 5 that further comprises:
roughly positioning the subject using the low magnification image; and
refining the position of the subject using the high magnification image.

7. A method as recited in claim 5 that further comprises irradiating the area of interest using an illumination source.

8. A method as recited in claim 5, wherein the step of gathering light reflected from an area of interest is performed using an objective lens.

9. A method as recited in claim 5, wherein the step of directing the reflected light along separate high and low magnification paths is performed using a beam splitter.

10. A method as recited in claim 5 that further comprises:
capturing the high magnification image using a first camera; and
capturing the low magnification image using a second camera.

11. A method as recited in claim 5, wherein the high magnification image is coaxially included in the low magnification image.

12. A method of optically inspecting and evaluating a subject comprising the steps of:
(a) gathering light reflected from an area of interest within the subject;
(b) concurrently generating separate high and low magnification images of the area of interest using the reflected light;
(c) roughly positioning the subject using the low magnification image;
(d) refining the position of the subject using the high magnification image;
(e) projecting a probe beam at the positioned subject; and
(f) measuring the light reflected from the subject.

13. A method as recited in claim 12 that further comprises irradiating the area of interest using an illumination source.

14. A method as recited in claim 12, wherein the step of gathering light reflected from an area of interest is performed using an objective lens.

15. A method as recited in claim 12, wherein the step of directing the reflected light along separate high and low magnification paths is performed using a beam splitter.

16. A method as recited in claim 12 that further comprises:
capturing the high magnification image using a first camera; and
capturing the low magnification image using a second camera.

17. A method as recited in claim 12 that further comprises:
directing the reflected light along separate high and low magnification paths; and
projecting the light on the high and low magnification paths through one or more lenses to generate the high and low magnification images of the area of interest.

18. A method as recited in claim 12, wherein the high magnification image is coaxially included in the low magnification image.
